(19) United States
(12) Patent Application Publication
(10) Pub. No.: US 2020/0272013 A1
(43) Pub. Date: Aug. 27, 2020

(54) ELECTROCHROMIC DEVICE BASED ON THREE-DIMENSIONAL MOTION OF LITHIUM IONS AND APPLICATION THEREOF

(71) Applicant: WUYI UNIVERSITY, Jiangmen City, Guangdong (CN)

(72) Inventors: Xiufeng TANG, Jiangmen City, Guangdong (CN); Jianyi LUO, Jiangmen City, Guangdong (CN); Siyuan WANG, Jiangmen City, Guangdong (CN); Jingcheng HUANG, Jiangmen City, Guangdong (CN); Guoxin CHEN, Jiangmen City, Guangdong (CN); Zhaopeng MO, Jiangmen City, Guangdong (CN); Guoxiang ZHENG, Jiangmen City, Guangdong (CN)

(21) Appl. No.: 16/315,603

(22) PCT Filed: Mar. 2, 2018
(86) PCT No.: PCT/CN2018/077828

§ 371 Date: Jan. 4, 2019

(30) Foreign Application Priority Data
Feb. 27, 2018 (CN) 201810160532.X

(51) Int. Cl. G02F 1/1524; G02F 1/155; G02F 1/1343; G02F 1/163

(52) U.S. Cl. CPC G02F 1/1524; G02F 1/155; G02F 1/163; G02F 1/134309; G02F 1/13439

(57) ABSTRACT

Provided are an electrochromic device based on three-dimensional motion of lithium ions and an application thereof. The electrochromic device based on three-dimensional motion of lithium ions comprises an upper and an lower transparent electrode layer, and an electrolyte layer and a discoloration layer which are arranged between the upper transparent electrode layer and the lower transparent electrode layer. A first external circuit is connected between the upper transparent electrode layer and the lower transparent electrode layer; and a second external circuit is connected between two ends of the transparent electrode layer adjacent to the discoloration layer. The electrochromic device realizes intelligent dimming based on three-dimensional motion of lithium ions.

### FIELD OF TECHNOLOGY

The present invention relates to the field of electrochromism, in particular to an electrochromic device based on three-dimensional motion of lithium ions and an application thereof.

### BACKGROUND

An electrochromic material is an intelligent material which can be subjected to stable and reversible color changes under external electric stimulation and which also possesses a capability of optical modulation. An electrochromic device with a sandwich structure can be obtained with the electrochromic material as a core layer and through matching with assembly of corresponding electrolyte layer and counter electrode layer. The electrochromic device can be used in such fields as assembly windows (also known as smart windows) of buildings, displays, file encryption and photo-grey glasses.

At present, a common standard structure of an electrochromic device is a battery-like sandwich structure integrated by multiple types of materials, including a five-layer structure composed of transparent conductive materials, electrochromic materials and electrolyte materials which are deposited at glass substrates at two sides. The structure can be expressed as a transparent conductive substrate (TC)/an electrochromic layer (EC)/an electrolyte (EL)/a counter electrode layer (CE)/a transparent conductive substrate (TC). Limited by the problem of stability of materials of a counter electrode layer (CE), a cycle life of the device is short, thereby influencing large-scale commercial applications of the electrochromic device.

### SUMMARY

Based on this, an objective of the present invention is to overcome defects and shortcomings of the prior art, and provide an electrochromic device based on three-dimensional motion of lithium ions. The electrochromic device has the advantages of no need of configuration of a counter electrode layer, simple structure and low manufacturing cost.

The objective of the present invention is realized through the following technical solutions: an electrochromic device based on three-dimensional motion of lithium ions, comprising an upper transparent electrode layer, a lower transparent electrode layer, and an electrolyte layer and a discoloration layer which are arranged between the upper transparent electrode layer and the lower transparent electrode layer, wherein a first external circuit is connected between the upper transparent electrode layer and the lower transparent electrode layer for providing an initialization voltage; and a second external circuit is connected between two ends of a transparent electrode layer adjacent to the discoloration layer in the upper transparent electrode layer and the lower transparent electrode layer for providing a transverse operating voltage.

The working principle of the present invention is as follows: applying an initialization voltage, and implanting lithium ions into a discoloration layer from an electrolyte layer, such that the discoloration layer is uniformly colored, light transmittance is lowered, and the state of the discoloration layer is referred to as an initialized state; after initialization is finished, removing the initialization voltage, at this time, the device is in a normally closed mode; applying a transverse operating voltage, such that the lithium ions move to the side of a negative electrode, then the light transmittance of a part of area of the discoloration layer is increased, and this part of area is in a discolored state, while the light transmittance of the other part of area of the discoloration layer is lowered, and this part of area is in a deeply colored state; and removing the transverse operating voltage, and diffusing the deeply colored area of the discoloration layer to the discolored area, such that the whole discoloration layer is in a uniformly colored state, and the device returns to a normally closed mode.

Compared with the prior art, the electrochromic device in the present invention realizes intelligent dimming based on three-dimensional motion of lithium ions, that is, lithium ions are implanted into a discoloration layer from an electrolyte layer, and migrate in the discoloration layer. Compared with an electrochromic device with a traditional sandwich structure, the electrochromic device in the present invention has the characteristics that no counter electrode layer (or ion storage layer) is required, thereby avoiding the problem of unstable material of a counter electrode layer and improving service life of the device; and the electrochromic device in the present invention also has the characteristics that the normally closed mode of the device is in a colored state, moreover, the manufacturing process is simple and the cost is low.

Further, the upper transparent electrode layer and the lower transparent electrode layer are selected from a group consisting of a transparent conductive oxide film, a carbon nanotube film, a graphene film, a silver nanowire film and a combination combining multiple selections of these films. Further, the electrolyte layer is a gel electrolyte layer, an all-solid electrolyte layer or a liquid electrolyte layer.

Further, the electrolyte layer has a thickness of 100 nm˜2 mm.

Further, the discoloration layer is an electrochromic metal oxide film, preferably a tungsten oxide film, a titanium oxide film or a vanadium oxide film.

Further, the electrochromic device based on three-dimensional motion of lithium ions further comprises an adhesion agent, wherein the adhesion agent is arranged in a relative gap between the upper transparent electrode layer and the lower transparent electrode layer, so as to realize encapsulation.

The present invention further provides a method for controlling an electrochromic device based on three-dimensional motion of lithium ions, comprising the following steps:

S1: applying an initialization voltage between an upper transparent electrode layer and a lower transparent electrode layer, and implanting lithium ions into a discoloration layer from an electrolyte layer, such that the discoloration layer is uniformly colored, light transmittance of the discoloration layer is lowered, and the discoloration layer is in an initialized state;

S2: removing the initialization voltage, applying a transverse operating voltage between two ends of a transparent electrode layer which is adjacent to the discoloration layer, and migrating the lithium ions in the discoloration layer, such that light transmittance of a part of area of the discoloration layer is increased, and this part of area is in a discolored state, while light transmittance of the other part of area is lowered, and this part of area is in a deeply colored state; and

S3: removing the transverse operating voltage, and diffusing lithium ions in the discoloration layer from an area in a deeply colored state to an area in a discolored state, such that the discoloration layer restores to a uniformly colored state.

Compared with the prior art, in the electrochromic device in the present invention, based on the driving of two voltages, lithium ions are firstly implanted to a discoloration layer from an electrolyte layer, and then are migrated in the discoloration layer, and a transition of multiple different degrees of color states of the device can be realized through three-dimensional motion of lithium ions, therefore, the electrochromic device has a favorable application prospect in such fields as smart windows, displays, file encryption and photo-grey glasses.

Further, light transmittance of the discoloration layer in a discolored state is greater than light transmittance of the discoloration layer in an initialized state, while light transmittance of the discoloration layer in an initialized state is greater than light transmittance of the discoloration layer in a deeply colored state.

Further, the initialization voltage has a value of 2˜3V, and the transverse operating voltage has a value of 3˜50V.

Further, the method for controlling an electrochromic device based on three-dimensional motion of lithium ions further comprises step S4: applying an initialization voltage again between the upper transparent electrode layer and the lower transparent electrode layer, such that the discoloration layer restores to an initialized state. After multiple recycling, the light transmittance of the electrochromic device in an initial colored state will be increased, the color becomes shallow, and an initialization voltage can be loaded again, such that the electrochromic device restores to an initialized state.

For a better understanding and implementation, the present invention will be described in detail below in combination with accompanying drawings.

### BRIEF DESCRIPTION OF THE DRAWINGS

FIG. 1 is a structural schematic diagram of an electrochromic device based on three-dimensional motion of lithium ions in embodiment 1.

FIG. 2 is an effect diagram of an application of an electrochromic device based on three-dimensional motion of lithium ions in embodiment 1 in a dimming window.

FIG. 3 is an effect diagram of an application of an electrochromic device based on three-dimensional motion of lithium ions in embodiment 1 in character display.

### DETAILED DESCRIPTION

In order to make the objective, technical solutions and advantages of the present invention clearer, the present invention will be further described in detail below in combination with accompanying drawings and embodiments. It should be understood that, specific embodiments described herein are merely used for explaining the present invention, rather than limiting the present invention. In addition, technical solutions mentioned in each embodiment of the present invention described below can be combined with each other as long as the technical solutions do not constitute a conflict.

### Embodiment 1

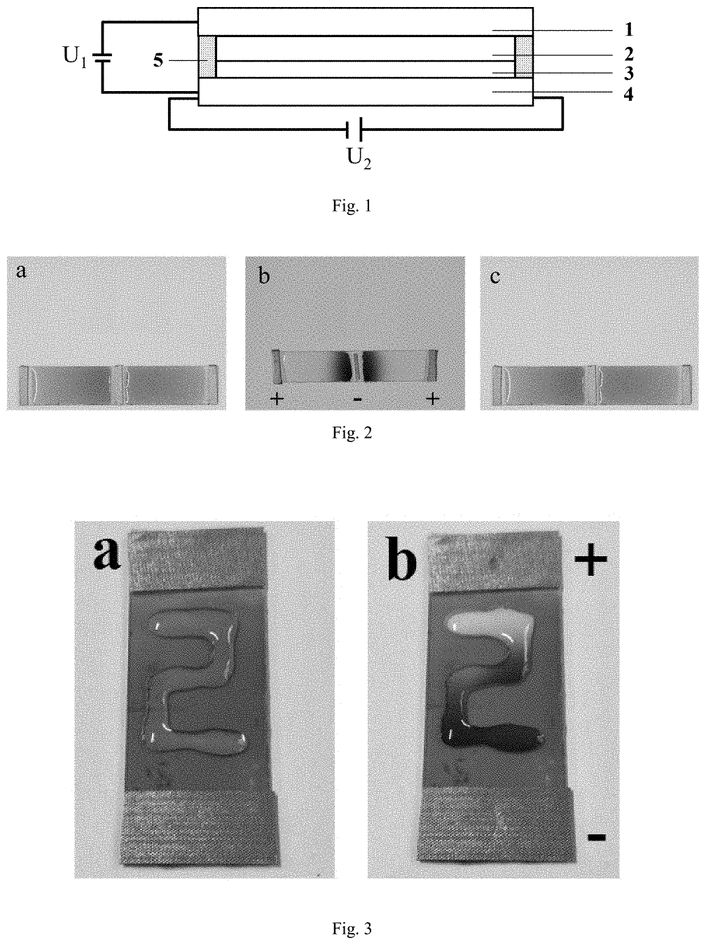

Please refer to FIG. 1 which is a structural schematic diagram of an electrochromic device based on three-dimensional motion of lithium ions in the present embodiment. The electrochromic device comprises an upper transparent electrode layer, a lower transparent electrode layer, and an electrolyte layer and a discoloration layer which are arranged between the upper transparent electrode layer and the lower transparent electrode layer, wherein a first external circuit is connected between the upper transparent electrode layer and the lower transparent electrode layer for providing an initialization voltage; and a second external circuit is connected between two ends of a transparent electrode layer adjacent to the discoloration layer in the upper transparent electrode layer and the lower transparent electrode layer for providing a transverse operating voltage.

Specifically, in the present embodiment, the electrochromic device comprises an upper transparent electrode layer 1, an electrolyte layer 2, a discoloration layer 3 and a lower transparent electrode layer 5 in sequence from top to bottom, wherein the layers of structures are in parallel with each other and are arranged in a stacking manner, and an adhesion agent 5 is used in a relative gap between the upper transparent electrode layer 1 and the lower transparent electrode layer 4 for encapsulation. A first external circuit is connected between the upper transparent electrode layer 1 and the lower transparent electrode layer 4, and is configured for providing an initialization voltage U₁, and the direction of the initialization voltage U₁ is toward the lower transparent electrode layer 4 from the upper transparent electrode layer 1. A second external circuit is connected between two ends of a lower transparent electrode layer 2, and is configured for providing a transverse operating voltage U₂, and the direction of the transverse operating voltage U₂ is in parallel with the lower transparent electrode layer 2.

The upper transparent electrode layer 1 and the lower transparent electrode layer 4 are selected from a group consisting of a transparent conductive oxide film, a carbon nanotube film, a graphene film, a silver nanowire film and a combination combining multiple selections of these films. The electrolyte of the electrolyte layer 2 can be gel electrolyte, all-solid electrolyte or liquid electrolyte, with a thickness of 100 nm˜2 mm. The material of the discoloration layer can be inorganic electrochromic material, preferably a tungsten oxide film, a titanium oxide film, a vanadium oxide film or other electrochromic metal oxide films.

The present embodiment further provides a method for controlling an electrochromic device based on three-dimensional motion of lithium ions, comprising the following steps:

(1) applying an initialization voltage U₁ between the upper transparent electrode layer and the lower transparent electrode layer, lithium ions are implanted into a discoloration layer from an electrolyte layer under the effect of the initialization voltage U₁, such that the discoloration layer is uniformly colored, light transmittance of the discoloration layer is lowered, and after the initialization voltage U₁ is loaded for a certain time, the discoloration layer is in an initialized state; after initialization is finished, removing the initialization voltage U₁, at this time, the device is in a normally closed mode. Preferably, the initialization voltage U₁ has a value of 2˜3V.

(2) applying a transverse operating voltage U₂ at two ends of a lower transparent electrode layer, under the driving of the transverse operating voltage U₂, lithium ions migrate towards the side of a negative electrode in the discoloration layer, such that the light transmittance of a part of area of the discoloration layer is increased, and this part of area is in a discolored state, while the light transmittance of the other part of area is lowered, and this part of area is in a deeply colored state. An area proportion between the area in a discolored state and the area in a deeply colored state is respectively related to the size of the transverse operating voltage U₂ and the duration of acting time of the transverse operating voltage U₂, that is, the bigger the operating voltage is, the longer the acting time is, and the bigger the area proportion between the area in a discolored state and the area in a deeply colored state is, preferably, the transverse operating voltage U₂ has a value of 3˜50V. The light transmittance of the discoloration layer in a discolored state is greater than the light transmittance of the discoloration layer in an initialized state, while the light transmittance of the discoloration layer in an initialized state is greater than the light transmittance of the discoloration layer in a deeply colored state.

(3) removing the transverse operating voltage U₂, lithium ions are diffused in the discoloration layer from the area in a deeply colored state to the area in a discolored state, such that the discoloration layer restores to its uniformly colored state, and the device returns to a normally closed mode.

(4) through multiple recycling (that is, transitions between a normally closed mode and a discolored state), the light transmittance of an electrochromic device in the normally closed mode will be increased, the color becomes shallow, the operation of step (1) can be repeated, and an initialization voltage U₁ is loaded again, such that the device restores to its initialized state.

### Embodiment 2

The present embodiment shows an application of an electrochromic device of embodiment 1 in dimming windows. Please refer to FIG. 2 which is an effect diagram. In order to better display the discoloring principles and effects of the present embodiment, the device in FIG. 2(a) has been subjected to initialization with the upper transparent electrode layer being removed, at this time, the device is in a normally closed mode; after a transverse operating voltage U₂ is loaded through an external circuit, lithium ions move to the negative electrode direction under the effect of an electric field, such that a part of area of the discoloration layer has an increased light transmittance and is in a discolored state, while the other part of area of the discoloration layer has a lowered light transmittance and is in a deeply colored state, as shown in FIG. 2(b); after the transverse operating voltage U₂ is removed, lithium ions are diffused to the area in a discolored state from the area in a deeply colored state in the discoloration layer, until the whole discoloration layer is in a uniformly colored state, and returns to a normally closed mode, that is, FIG. 2(c). Users can control the size of the discolored area through adjusting the switching and acting time of the transverse operating voltage U_{2,} thereby realizing controlling of opening and closing of an electrochromic dimming window based on three-dimensional motion of lithium ions.

### Embodiment 3

The present embodiment shows an application of an electrochromic device of embodiment 1 in character display. Please refer to FIG. 3 which is an effect diagram. In order to better display the discoloring principles and effects of the present embodiment, the device in FIG. 3(a) has been subjected to initialization with the upper transparent electrode layer being removed, at this time, the device is in a normally closed mode, wherein the shape of the electrolyte layer is like a character “2”, and since the electrolyte is transparent gel, the character “2” is not easily visible when it is hidden under the background; after a transverse operating voltage U₂ is loaded, lithium ions move to the negative electrode direction under the effect of an electric field, such that the upper half part of area of the character “2” has an increased light transmittance and is in a discolored state, while the lower half part of area of the character “2” has a lowered light transmittance and is in a deeply colored state, as shown in FIG. 3(b), at this time, the light transmittance of the upper and lower half parts of areas of the character “2” differs greatly from the light transmittance of the background area, while such a difference can be visible by human eyes, then users can distinguish the character to be “2”, therefore, an electrochromic character display effect based on three-dimensional motion of lithium ions can be realized.

Based on a working principle of the present invention, the pattern displayed by the device is realized through adjusting the shape of an electrolyte layer. Therefore, users use an electrolyte solution to write any character on a surface of the discoloration layer, and display the character through the above steps, then the functions of data encryption and display can be realized, and the electrochromic device has a favorable application prospect in the encryption field. Compared with the prior art, an electrochromic device in the present invention realizes intelligent dimming based on three-dimensional motion of lithium ions, that is, lithium ions are implanted into a discoloration layer from an electrolyte layer, and migrate in the discoloration layer.

Compared with an electrochromic device with a traditional sandwich structure, the electrochromic device in the present invention has the characteristics that no counter electrode layer (or ion storage layer) is required, and the normally closed mode of the device is in a colored state, moreover, the manufacturing process is simple and the cost is low, therefore, the electrochromic device in the present invention has a favorable application prospect in such fields as smart windows, displays, file encryption and photo-grey glasses.

The above embodiments are merely several embodiments of the present invention, and the description of the above embodiments is specific and detailed, however, the above embodiments cannot be hence deemed as a limitation to the patent scope of the present invention. It should be noted that, for those skilled in the art, on the premise of not departing from the conception of the present invention, numerous deformations and improvements can be made, and these deformations and improvements shall all fall within the protection scope of the present invention.

1. An electrochromic device based on three-dimensional motion of lithium ions, comprising an upper transparent electrode layer, a lower transparent electrode layer, and an electrolyte layer and a discoloration layer which are arranged between the upper transparent electrode layer and the lower transparent electrode layer, wherein a first external circuit is connected between the upper transparent electrode layer and the lower transparent electrode layer for providing an initialization voltage; and a second external circuit is connected between two ends of a transparent electrode layer adjacent to the discoloration layer in the upper transparent electrode layer and the lower transparent electrode layer for providing a transverse operating voltage.

2. The electrochromic device based on three-dimensional motion of lithium ions according to claim 1, wherein the upper transparent electrode layer and the lower transparent electrode layer are selected from a group consisting of a transparent conductive oxide film, a carbon nanotube film, a graphene film, a silver nanowire film and a combination combining multiple selections of these films.

3. The electrochromic device based on three-dimensional motion of lithium ions according to claim 1, wherein the electrolyte layer is a gel electrolyte layer, an all-solid electrolyte layer or a liquid electrolyte layer.

4. The electrochromic device based on three-dimensional motion of lithium ions according to claim 1, wherein the electrolyte layer has a thickness of 100 nm˜2 mm.

5. The electrochromic device based on three-dimensional motion of lithium ions according to claim 1, wherein the discoloration layer is an electrochromic metal oxide film.

6. The electrochromic device based on three-dimensional motion of lithium ions according to claim 1, further comprising an adhesion agent, wherein the adhesion agent is arranged in a relative gap between the upper transparent electrode layer and the lower transparent electrode layer, so as to realize encapsulation.

7. A method for controlling an electrochromic device based on three-dimensional motion of lithium ions, comprising the following steps:
S1: applying an initialization voltage between an upper transparent electrode layer and a lower transparent electrode layer, and implanting lithium ions into a discoloration layer from an electrolyte layer, such that the discoloration layer is uniformly colored, light transmittance of the discoloration layer is lowered, and the discoloration layer is in an initialized state;
S2: removing the initialization voltage, applying a transverse operating voltage between two ends of a transparent electrode layer which is adjacent to the discoloration layer, and migrating the lithium ions in the discoloration layer, such that light transmittance of a part of area of the discoloration layer is increased, and this part of area is in a discolored state, while light transmittance of the other part of area is lowered, and this part of area is in a deeply colored state; and
S3: removing the transverse operating voltage, and diffusing lithium ions in the discoloration layer from an area in a deeply colored state to an area in a discolored state, such that the discoloration layer restores to a uniformly colored state.

8. The method for controlling an electrochromic device based on three-dimensional motion of lithium ions according to claim 7, wherein light transmittance of the discoloration layer in a discolored state is greater than light transmittance of the discoloration layer in an initialized state, while light transmittance of the discoloration layer in an initialized state is greater than light transmittance of the discoloration layer in a deeply colored state.

9. The method for controlling an electrochromic device based on three-dimensional motion of lithium ions according to claim 7, wherein the initialization voltage has a value of 2˜3V, and the transverse operating voltage has a value of 3˜50V.

10. The method for controlling an electrochromic device based on three-dimensional motion of lithium ions according to claim 7, further comprising step S4: applying an initialization voltage again between the upper transparent electrode layer and the lower transparent electrode layer, such that the discoloration layer restores to an initialized state.

11. The method for controlling an electrochromic device based on three-dimensional motion of lithium ions according to claim 8, wherein the initialization voltage has a value of 2˜3V, and the transverse operating voltage has a value of 3˜50V.

12. The method for controlling an electrochromic device based on three-dimensional motion of lithium ions according to claim 8, further comprising step S4: applying an initialization voltage again between the upper transparent electrode layer and the lower transparent electrode layer, such that the discoloration layer restores to an initialized state.
